(19) United States
(12) Patent Application Publication
(10) Pub. No.: US 2013/0254040 A1
(43) Pub. Date: Sep. 26, 2013

(54) SYSTEMS AND METHODS FOR PROVIDING PROMOTIONAL CONTENT DURING A CALL ATTEMPT

(71) Applicant: Kumaresan Ellappan, Bangalore Karnataka (IN)

(72) Inventor: Kumaresan Ellappan, Bangalore Karnataka (IN)

(21) Appl. No.: 13/989,129

(22) PCT Filed: Oct. 21, 2011
(86) PCT No.: PCT/US2011/057371

§ 371 Date: May 23, 2013

(30) Foreign Application Priority Data
Apr. 20, 2011 (IN) 1168/DEL/2011

(51) Int. Cl. G06Q 30/02

(52) U.S. Cl. CPC G06Q 30/0269
USPC 705/14.66

(57) ABSTRACT

Systems and methods for call management for providing promotional content in a telecommunications network are described herein. A dialed telephone number is determined from a call request. The call request originates from a mobile device of a user. During a call attempt, promotional content that correlates with the dialed telephone number is provided.

### I. BACKGROUND

Advertising is a technique by which sellers of products and/or services communicate with potential purchasers to persuade them to take some action, such as purchase the goods and/or services they are selling, disperse information, convey a message, or promote a cause. Advertising through telecommunication channels has increased in importance taking into account the fast-growing mobile market. Mobile devices, such as cell phones, smart phones, handhelds, tablets, and other portable computing devices, offer to advertisers direct marketing opportunities. Under many circumstances, users of mobile devices are bombarded with unwanted advertisements.

Subscription-based marketing campaigns rely on providing advertising material based on a user's preferences or selections. Typical advertisement systems of this type can provide a customized advertising service based on preference or context information related to a user's profile. Even these and other pull-based marketing approaches may result in unwanted messages or messages perceived to be spam which occupy space in the mobile device inbox, causing the user to delete or manage the messages. As such, advertisers are limited in their ability to effectively reach audiences who are genuinely interested in receiving the advertisement material.

### II. BRIEF DESCRIPTION OF THE DRAWINGS

The present disclosure may be better understood and its numerous features and advantages made apparent to those skilled in the art by referencing the accompanying drawings.

FIG. 1 is a topological block diagram of a telecommunications network in accordance with an embodiment.

FIG. 2 is a process flow diagram for registration of an ad provider for a call management service in accordance with an embodiment.

FIG. 3 is a process flow diagram for call management in accordance with an embodiment,

FIG. 4A is a message flow diagram for validation by an originating switch and call management including tracking of caller identifiers in accordance with an embodiment.

FIG. 4B is a message flow diagram for validation by a destination switch and call management in accordance with an embodiment.

FIG. 5 illustrates a computer system in which an embodiment may be implemented.

### III. DETAILED DESCRIPTION

Service providers offer services to their customers in response to customer orders, change requests and other processes. One particular class of service providers is telecommunications service providers, which provide telecommunication services to their customers, referred to as subscribers. Telecommunications services currently include both wire line and wireless technologies. Examples of wire line telecommunication services include telephone service and related services such as voice mail, call forwarding, three way calling and caller identification, or cable television service and associated cable-provided services, such as Internet access. Examples of wireless telecommunication services include cellular telephone service and associated services such as voice mail and three way calling, wireless electronic mail and paging.

More and more types of services are emerging on various networks. Telecommunications networks in particular are expanding offerings of new services. A service for providing promotional content is implemented for providers of the promotional content and users of telecommunications services. A content provider enrolls for the service and users access the promotional content by calling a telephone number registered to the content provider.

Systems and methods for call management for providing promotional content in a telecommunications network are described herein. A dialed telephone number is determined from a call request. The call request originates from a mobile device of a user. During a call attempt, promotional content that correlates with the dialed telephone number is provided.

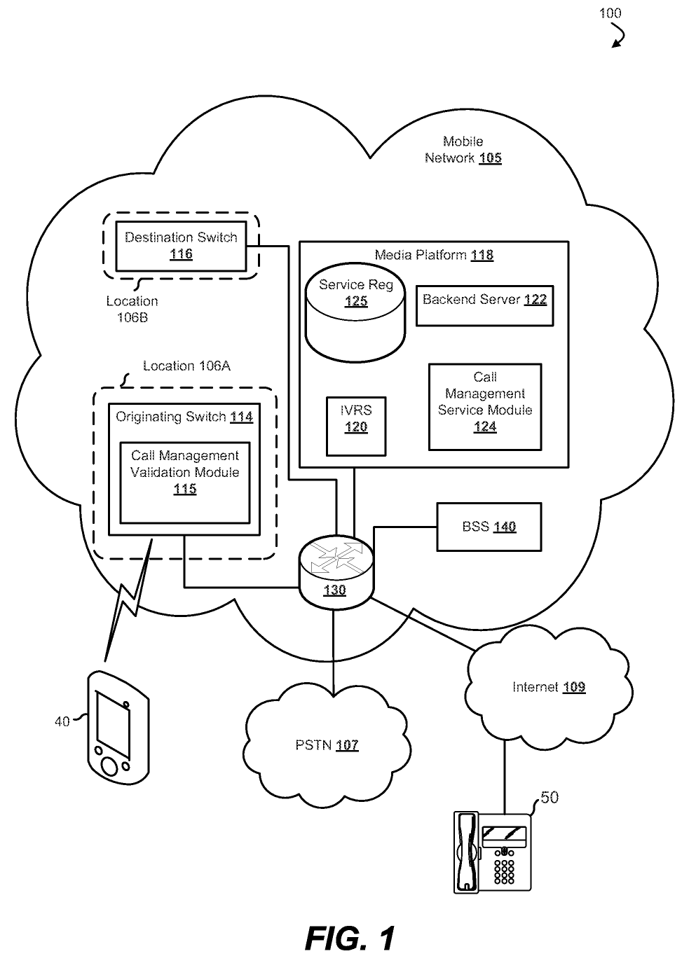

FIG. 1 is a topological block diagram of a telecommunications network 100 in accordance with an embodiment. The telecommunications network 100 is described according to the general infrastructure and nomenclature of the Global System for Mobile Communications (GSM) standards although embodiments are not limited to application in such systems, and description thereof is for illustrative purposes. Network 100 includes a mobile network 105, a Public Switched Telephone Network (PSTN) 107, internet 109.

Mobile network 105 includes an originating switch 114, destination switch 116, a business support system (BSS) 140, a media platform 118, and a router 130, all of which are operatively interconnected and the connection among them may include multiple network segments, transmission technologies and components.

Originating switch 114 is configured to route data in location 106A of mobile network 105 and manage the communication between mobile devices and PSTN 107. Destination switch 114 is configured to route data to a served party, for example in location 106B of mobile network 105, and manage the communication between mobile devices and PSTN 107. In a GSM mobile network, originating switch 114 and destination switch 116 may be Mobile Switching Centers (MSCs). As shown, originating switch 114 and destination switch 116 service different switching system locations in mobile network 105. Originating switch 114 services a location 106A and destination switch 116 services location 106B. In another embodiment, originating switch 114 and destination switch 116 are the same device, for example where a caller using mobile device 40 and an ad provider are both serviced by the same location, e.g., either location 106A or location 106B.

Media platform 118 is configured to deliver and manage mobile voice and data services. Media platform 118 includes Interactive Voice Response Server (IVRS) 120, backend server 122, call management service module 124, and a service registry 125, all of which are operatively interconnected and the connection among them may include multiple network segments, transmission technologies and components.

IVRS 120 is configured to enable interaction between users and various components of mobile network 105 via keypad inputs from a device of the user or by speech recognition. Specifically, IVRS 120 is configured to enable access to service registry 125 by a subscriber using voice service (via a mobile device or landline), Short Message Service (SMS), Multimedia Messaging Service (MMS), Unstructured Supplementary Service Data (USSD), among others.

Backend server 122 generally is configured to enable services within mobile network 105. Call management service module 124 is configured to enroll a promotional ad provider with a call management service and provide access for subscribers (e.g., users of mobile devices) to enrolled promotional content. Call management service module 124 is shown as being implemented as a standalone module, but may be implemented on a single server, such as backend server 122 and IVRS 120, or by multiple servers. Each such server is programmed with machine readable instructions, and may include at least one processor for executing these instructions stored in a machine readable memory.

Service registry 125 is a data store configured to store enrolled promotional content, for example in a table. Specifically, service registry 125 includes a mapping of telephone numbers of promotional content providers and one or more works of promotional content for each telephone number. The telephone numbers have been previously enrolled for the call management service. Router 130 is generally configured to process and transfer data in network 100. Router 130 is an edge device on the edge of a network, such as mobile network 105. As used herein, an edge device is a network switch, router, or other network device on the edge of a network.

Business support systems (BSS) 140 is configured to support various end-to-end services including billing, charging, and settlement. Typically, services are enforced by a charging policy. As such, the call management service is enforced according to a corresponding charging policy.

In operation, a provider of promotional content may offer a call management service for subscribers such as users of mobile devices. In one embodiment, enrollment in the call management service may be initiated by the provider of promotional content (hereinafter, “ad provider”) via an enrollment request. The enrollment request specifies a phone number associated with the ad provider. Where the enrollment request is provided via a mobile device (e.g., a voice call using mobile voice service), the incoming call is sent to call management service module 124 via IVRS 120 for processing. The enrollment request may be provided to a sub-module of call management service module 124 that handles registration for ad providers.

Where the enrollment request is provided via a and line (e.g., ad provider calls the telecommunications service provider using a land line), the enrollment request is received by router 130 through PSTN 107, and is forwarded to call management service module 124 via IVRS 120. The enrollment request may be provided to a sub-module of call management service module 124 that handles registration for ad providers.

Where the enrollment request is provided via the internet (e.g., ad provider accesses a telecommunications service provider's website), the enrollment request is received by router 130 through internet 109, and is forwarded to call management service module 124 via backend server 122. Likewise, the enrollment request may be provided to a sub-module of call management service module 124 that handles registration for ad providers.

As a part of the call management service, subscribers may access correlated promotional content if a phone number of the ad provider is enrolled in the service. In one embodiment, access to the promotional content is initiated by subscribers making a call to the ad provider. For example, using mobile device 40, a subscriber dials a phone number (e.g., publicized toll-free number) that is known to be associated with the ad provider. More specifically, the subscriber may dial the registered phone number using mobile voice service. The call is routed to originating switch 114 for processing since mobile device 40 is within the service location 106A of originating switch 114. In one embodiment, originating switch 114 forwards the call to call management service module 124 via IVRS 120 if call management validation module 115 validates the dialed telephone number as a number that is associated with an ad provider who has enrolled in the call management service.

In another embodiment, the users and the promotional ad providers may subscribe to different service providers. The service may be achieved by implementing a similar call flow at the destination switch. For example, originating switch 114 forwards the call to destination switch 116. A call management validation module of the destination switch 116, in turn, determines whether the dialed number is enrolled for the service and where it is, destination switch 116 forwards the call to call management service module 124. In this scenario, media platform 118, which includes call management service module 124, belongs to the service provider with which the promotional ad provider is subscribed.

Once routed, call management service module 124 obtains the promotional content correlated with the dialed phone number, for example by performing a lookup in service registry 125. IVRS 120 provides the promotional content to the subscriber via a text message, multimedia message, or other message.

Typically, a call is attempted for a timeout period by the telecommunication service provider until the call is completed. For example, a user of mobile device 40 dials a telephone number associated with an ad provider. The call is routed to an Internet Protocol (IP) phone 50 of the ad provider, which causes IP phone 50 to ring indicating a call attempt. The call is completed, for example, if the callee answers the call or the call is answered by a voicemail service. As described herein, the correlating promotional content is provided to the user's mobile device before the call is established. In other words, the promotions are sent before the call is completed.

Embodiments can also be applied in other network topologies and environments. Telecommunications network 100 may be any type of network familiar to those skilled in the art that can support data communications using any of a variety of commercially-available protocols, including without limitation TCP/IP, SNA, IPX, AppleTalk, and the like. Merely by way of example, network 100 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol in the art, and/or any other wireless protocol); and/or any combination of these and/or other networks.

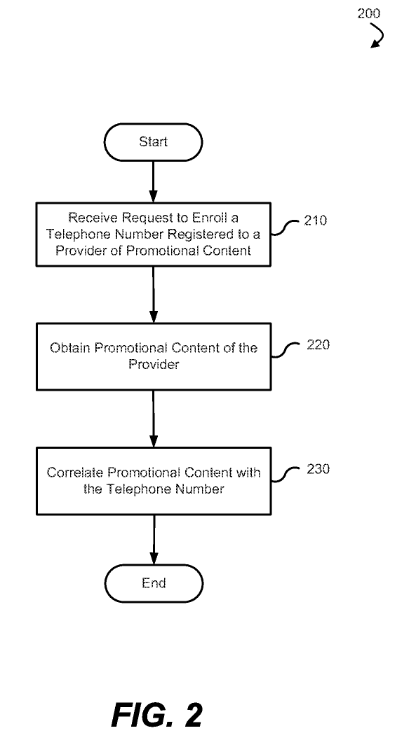

FIG. 2 is a process flow diagram for registration of an ad provider for a call management service in accordance with an embodiment. The depicted process flow 200 may be carried out by execution of sequences of executable instructions. In another embodiment, various portions of the process flow 200 are carried out by components of a telecommunication media platform, an arrangement of hardware logic, e.g., an Application-Specific Integrated Circuit (ASIC), etc. For example, blocks of process flow 200 may be performed by execution of sequences of executable instructions in a call management service module of the telecommunication media platform.

A call management service for providing promotional content is implemented in a telecommunications network for ad providers to enroll their phone number(s) and promotional content. The ad provider may initiate enrollment into the call management service. At step 210, a request to enroll a telephone number that has been registered to an ad provider is received, for example by a telecommunication media platform in a telecommunications network. In one embodiment, the enrollment is subscription-based, such as with other services, and may be discontinued or extended as desired.

The enrollment request specifies a telephone number registered to the ad provider. The telephone number may be a publicized toll-free number (e.g., 1-800 telephone number), business telephone number, or any other telephone number that is associated by a telephone carrier with the ad provider.

At step 220, promotional content from the ad provider is obtained, for example, the promotional content is provided by the ad provider to the telecommunication media platform. The promotional content may include advertisements, coupons, or other communication from a seller to a potential buyer. The promotional content may be provided in any of a variety of formats, such as in electronic or audio form. The provided data may be the promotion itself or any portion thereof, or in another embodiment, may be a reference to the promotion (e.g., hyperlink). The promotional content may be provided during an enrollment session.

At step 230, the promotional content is correlated with the telephone number of the ad provider. The correlation may be accomplished by storing in a database table, for example of a service registry, the telephone number as an index or unique key which is used to access the provided promotional content. Other methods of correlating the telephone number and promotional content may be implemented. It should be mentioned that multiple works of promotional data may be provided by the ad provider. A single telephone number may be correlated with each of the promotional data provided.

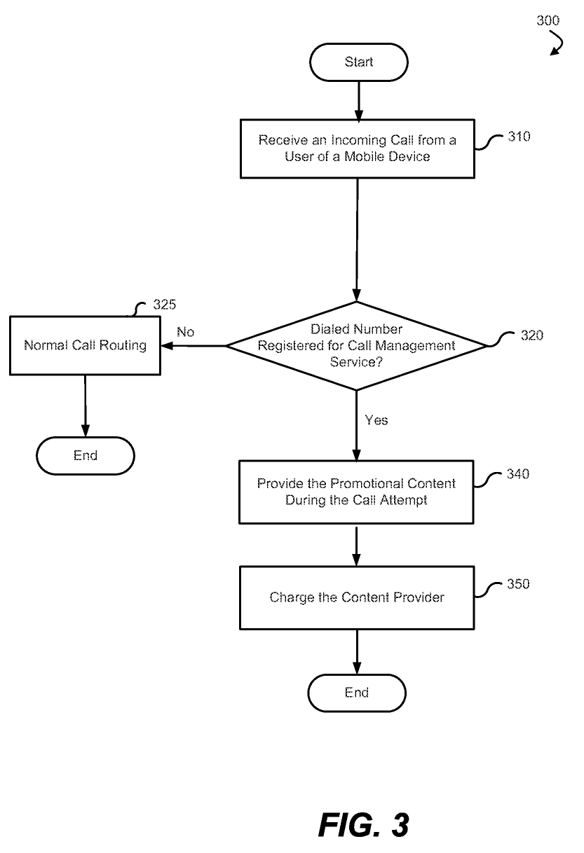

When correlation is complete, the ad provider's telephone number and promotional content is considered to be enrolled. As such, whenever access to the promotion or advertisement is desired, a user of a mobile device can simply place a call using the ad provider's telephone number. Access to the promotional content is further described in FIG. 3.

FIG. 3 is a process flow diagram for call management in accordance with an embodiment. The depicted process flow 300 may be carried out by execution of sequences of executable instructions. In another embodiment, various portions of the process flow 300 are carried out by components of a telecommunication media platform, a switch in a telecommunications network, an arrangement of hardware logic, e.g., an Application-Specific Integrated Circuit (ASIC), etc. For example, blocks of process flow 300 may be performed by execution of sequences of executable instructions in a call management system of an originating switch or a destination switch in the telecommunications network and/or a media platform in the telecommunications network.

A call management service for providing promotional content is implemented in the telecommunications network for users of mobile device for access to the promotional content. The caller may initiate such access.

At step 310, an incoming call from a user of a mobile device is received, for example, by an originating switch in the telecommunications network. As used herein, the originating switch is a device that is responsible for routing mobile calls that originated within its service area (e.g., geographic area). A call made from a mobile device is sent from a base station to an originating switch. In a mobile telecommunications network, such as the Global System for Mobile communications (GSM), the mobile call is sent from the base station to a Mobile Switching Center (MSC) that services the geographic area at which the mobile device is located.

In another embodiment, the incoming call is received by the destination switch. As used herein, the destination switch is a device that is responsible for routing calls to a served party. The incoming call may have been forwarded to the destination switch from the originating switch.

Upon receiving the incoming call, at step 320, it is determined whether the dialed telephone number is enrolled in the call management service. This may be performed by the originating switch or the destination switch in the telecommunications network. During enrollment of the ad provider, a data store, such as a service registry, is populated with the phone numbers of ad providers. The data store also includes a correlation of a phone number and the promotional content for each phone number. To determine whether the dialed telephone number is enrolled, a search is performed for the dialed telephone number. In particular, the dialed telephone number is compared to the telephone numbers in the data store.

If a match is not found, it is determined that the entity assigned to the dialed number is has not enrolled in the call management service, and processing continues to step 325, where the call is routed through the normal channels. For example, if the dialed number is a mobile number in a GSM network, the originating MSC routes the call to the MSC that is currently able to reach the called mobile subscriber (e.g., destination switch/MSC). The device of the called mobile subscriber is then paged in its current location area. If the dialed number is a telephone number having an endpoint in a PSTN, the originating MSC routes the call through a router that transfers the call through the PSTN. If the dialed number is associated with an IP address, the MSC routes the call through the internet. When an incoming call is routed to the destination device, the call is typically attempted by the service provider for the duration of the service provider's timeout period or until the call is complete.

On the other hand, if a match is found, it is determined that the entity assigned to the dialed number has indeed enrolled in the call management service. The call is then forwarded to the media platform. At step 340, the promotional content correlated with the dialed number is provided during the call attempt, for example by the media platform. In one embodiment, this is provided during the call attempt, i.e., after the mobile device of a user sends a call setup request and before the call is completed. Specifically, the media platform performs a lookup in the data store, using the dialed number as an index to locate the correlated promotional content. The promotional content is then provided to the user of the mobile device (i.e., caller) in one or more of various formats such as text message (SMS, etc.) or multimedia message. The promotional content is provided before the call is completed. By doing so, the user is served the desired content without incurring cost for usage of mobile minutes, since typical telecommunication billing systems begin the charge after the call is complete. Upon obtaining the requested promotional content, the user can simply end the call before it is completed. If the user chooses to continue, the call attempt continues.

At step 350, the content provider may be charged for the cost of network usage. For example, where the promotional content was delivered as an SMS message, the cost of transmission and/or receipt may be attributed to the ad provider and may not be charged to the user's own allocations and/or charges.

In this form of a pull model, the user is presented with those advertisements which are directly requested, rather than advertisements which are recommended or otherwise determined to be potentially relevant to the user based on profiles or preferences. In this manner, the user's experience may be enhanced with the presentation of relevant and useful data. In turn, this model may allow advertisers to more effectively reach potential customers who are genuinely interested in the promoted goods, services, etc., which may lead to increased sales, revenues, and profits for the advertisers and goods/services providers.

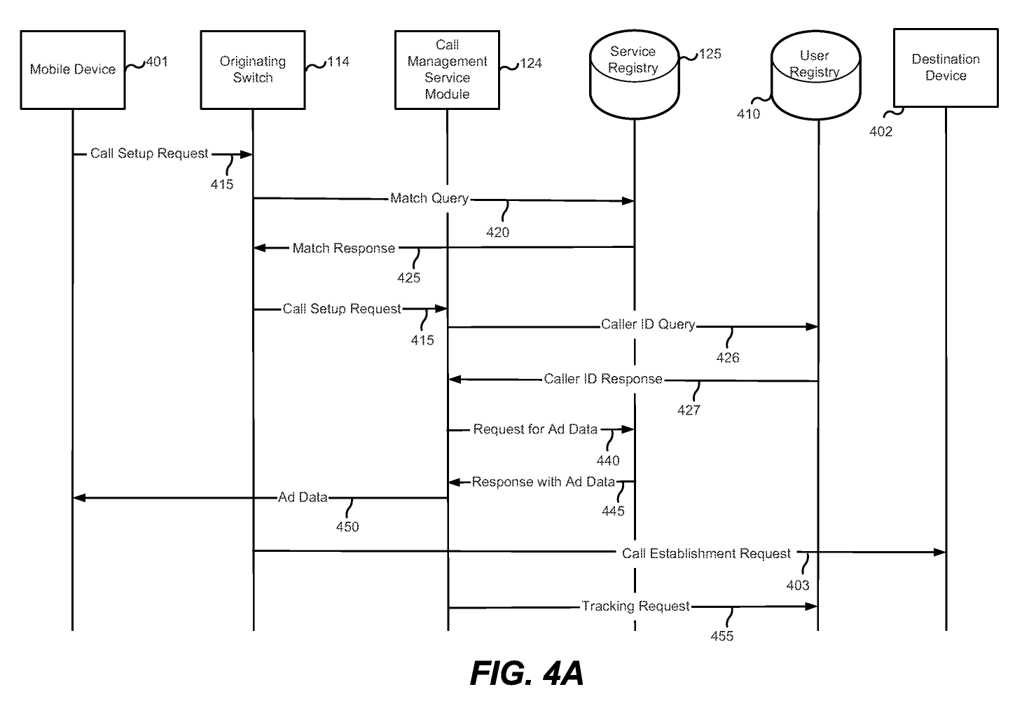

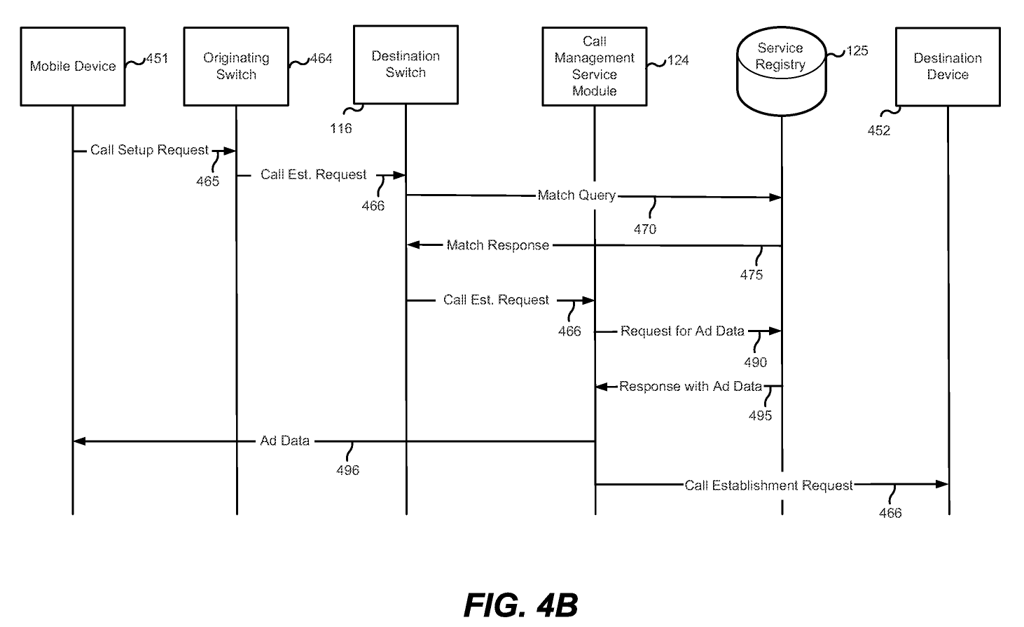

FIG. 4A is a message flow diagram for validation by an originating switch and call management including tracking of caller identifiers in accordance with an embodiment. In this example, a user initiates a call to an ad provider by dialing a phone number using a mobile device 401. The mobile device 401 sends a call setup request message 415 to the mobile telecommunications network via a base station and originating switch 114.

The call setup request message 415 is handled by originating switch 114, which checks whether the incoming call is allowed by referencing a subscriber record in a location register (e.g., Home Location Register, Visiting Location Register) of the service provider.

If allowed, originating switch 114 performs a service validation by sending a match query 420 to service registry 125. The match query 420 may be in the format of any signaling protocol, such as Signaling System Number 7 (SS7) and Session Initiation Protocol (SIP), among others. Service registry 125 obtains from the received match query 420 the called party's telephone number and performs a lookup for this telephone number. As previously described, service registry 125 includes the telephone numbers of ad providers enrolled in the call management service.

Originating switch 114 receives a match response 425, which is used to determine whether the call management service is enabled for the number dialed. No further service-related messages are sent if match response 425 indicates a match was unsuccessful. Furthermore, if there is no match, the call is routed through typical methods using a call establishment request to the destination switch. On the other hand, if match response 425 indicates a positive match (i.e., the number dialed is validated for the service), originating switch 114 forwards the call setup request 415 to a call management service module 124.

Users of the call management service may be tracked for various purposes. In one embodiment, a caller identification (ID) is obtained from call setup request 415. The caller identification may include a telephone subscriber number (MSISDN) associated with the user of mobile device 401.

A caller ID query 426 is sent to a user registry 410. The caller ID query 426 includes the dialed telephone number of the call as well as the caller identification. User registry 410 is a data store configured to store a listing of user identifications, such as a telephone subscriber number (MSISDN) of the device the user employed to make the call, and is operatively coupled to one or more components of a media platform. Additionally, user registry 410 is configured to track a user's access to promotional data associated with an ad provider.

Upon receiving the caller ID query 426, a lookup is performed by user registry 410 using the dialed telephone number as an index and determining whether the correlated promotional data had been previously sent to the user of mobile device 401. This determination may be accomplished by searching for a match using the caller identification from query 426. By using the dialed number and the caller identification, tracking may be accomplished to know if the caller has accessed promotional data, and also to know whether the caller accessed promotional data from a particular ad provider, or even whether the caller accessed specific promotional data (where there are multiple works of promotional data by the ad provider).

Call management service module 124 receives a caller ID response 427, which is used to determine whether the user has previously received the promotional data correlated with the dialed telephone number. No ad data messages are sent if caller ID response 427 indicates a match was found, i.e., the promotional data has already been accessed.

On the other hand, if caller ID response 427 indicates that no match was found, call management service module 124 obtains from the received call setup request 415 the called party's telephone number and sends a request 440 for the advertisement or promotional data that is correlated with the called party's telephone number. Service registry 125 performs a lookup using the called party's telephone number as a key and sends a response 445 which includes the correlated advertisement or promotional data. Call management service module 124 obtains the correlated advertisement or promotional data from response 445 and provides a message with the ad data 450 to mobile device 401. Furthermore, the call is routed through typical methods using a call establishment request 403 to the destination device 402, whether it be a mobile device, IP phone, a phone connected to a PSTN line, etc. For example, if the destination device is a phone connected to a PSTN line, the call establishment request 403 may include the called party's telephone number and is forwarded to an exchange in the PSTN, which then establishes a connection to destination device 402. In one embodiment, the call is routed to mobile device 401 using call establishment request 403 subsequent to providing the message with the ad data 450.

In one embodiment, the ad data 450 is provided before the call is completed. For example, the call may be completed where the call establishment request 403 is routed to destination device 402 and a user of destination device 402 answers the incoming call, causing the establishment of a connection. If the call is not established, the caller is not charged. As such, the service is free for the user since the call is not yet completed.

As previously mentioned, user registry 410 is configured to track a user's access to promotional data associated with an ad provider. For example, after the message with the ad data 450 is provided to or received by mobile device 401, a tracking request 455 is sent from call management service module 124 to user registry 410.

For purposes of illustration, tracking request 455 is shown as being sent after call establishment request 403 is sent from originating switch 114 to destination device 402. However, there is no such order or dependency between the timing of tracking request 455 and call establishment request 403, and as such, tracking request 455 may be sent before or after call establishment request 403, or both requests 455 and 403 may be sent in parallel.

User registry 410 obtains the caller identification (e.g., MSISDN) and the dialed telephone number from tracking request 455, and associates the caller identification with the dialed telephone number. Where the ad provider enrolls multiple works of promotional data, user registry 410 tracks the user identification for each work of promotional data that is accessed. In one embodiment, tracking may be performed when the request for ad data 440 or response 445 is made.

FIG. 4B is a message flow diagram for validation by a destination switch and call management in accordance with an embodiment. A caller, using mobile device 451, and the ad provider, using destination device 452, may subscribe to different providers of telecommunication service. The ad provider subscribes to the call management service of its own service provider (SP). To implement the service, this SP includes a switch, such as destination switch 116, and a media platform that includes a call module, such as call management service module 124. In this example, destination switch 116 includes a call management validation module, similar in functionality to call management validation module 115 of originating switch 114 of FIG. 1. By this implementation, a caller may access or otherwise use the service offered by a different SP.

A user initiates a call to an ad provider by dialing a phone number using a mobile device 451. The mobile device 451 sends a call setup request message 465 to the mobile telecommunications network via a base station and originating switch 464.

The call setup request message 465 is handled by originating switch 464, which checks whether the incoming call is allowed by referencing a subscriber record in a location register (e.g., Home Location Register, Visiting Location Register) of the service provider.

If allowed, originating switch 464 routes the call through typical methods and sends a call establishment request 466 to the destination switch 116, whether the destination device be a mobile device, IP phone, a phone connected to a PSTN line, etc. For example, if the destination device is a phone connected to a PSTN line, the call establishment request 466 may include the called party's telephone number and is eventually forwarded to the destination device via an exchange in the PSTN, which then establishes a connection to the destination device.

Destination switch 116 sends a match query 470 to service registry 125, The match query 470 may be in the format of any signaling protocol, such as Signaling System Number 7 (SS7) and Session Initiation Protocol (SIP), among others. Service registry 125 obtains from the received match query 470 the called party's telephone number and performs a lookup for this telephone number. As previously described, service registry 125 includes the telephone numbers of ad providers enrolled in the call management service.

Destination switch 116 receives a match response 475, which is used to determine whether the call management service is enabled for the number dialed. No ad data messages are sent if match response 475 indicates a match was unsuccessful. Furthermore, if there is no match, the call is routed through typical methods using a call establishment request to destination device 452. On the other hand, if match response 475 indicates a positive match (Le., number dialed is validated for the service), destination switch 116 forwards the call establishment request 460 to a call management service module 124.

Call management service module 124 obtains from the received call establishment request 460 the called party's telephone number and sends a request 490 for the advertisement or promotional data that is correlated with the called party's telephone number. Service registry 125 performs a lookup using the called party's telephone number as a key and sends a response 495 which includes the correlated advertisement or promotional data. Call management service module 124 obtains the correlated advertisement or promotional data from response 495 and provides a message with the ad data 496 to mobile device 451. Furthermore, the call is routed through typical methods using a call establishment request 466 to destination device 452. For example, if destination device 452 is a mobile device, a paging message is sent from a base station and is received by the mobile device. An acknowledgement message is sent by the mobile device to the base station. After this handshake, the base station signals the mobile device to notify the user of the incoming call, for example by ringing.

In one embodiment, the message with the ad data 496 is provided during the call attempt, e.g., before the call is completed or is established. In one example, the ad data is provided before call management service module 124 routes the call to destination device 452 through the typical channels using call establishment request 466. If the call is not established, the caller is not charged. As such, the service is free for the user since the call is not yet completed.

Tracking of user access to promotional data may also be performed, for example using call management service module 124 and a user registry, such as user registry 410 as described with respect to FIG. 4A.

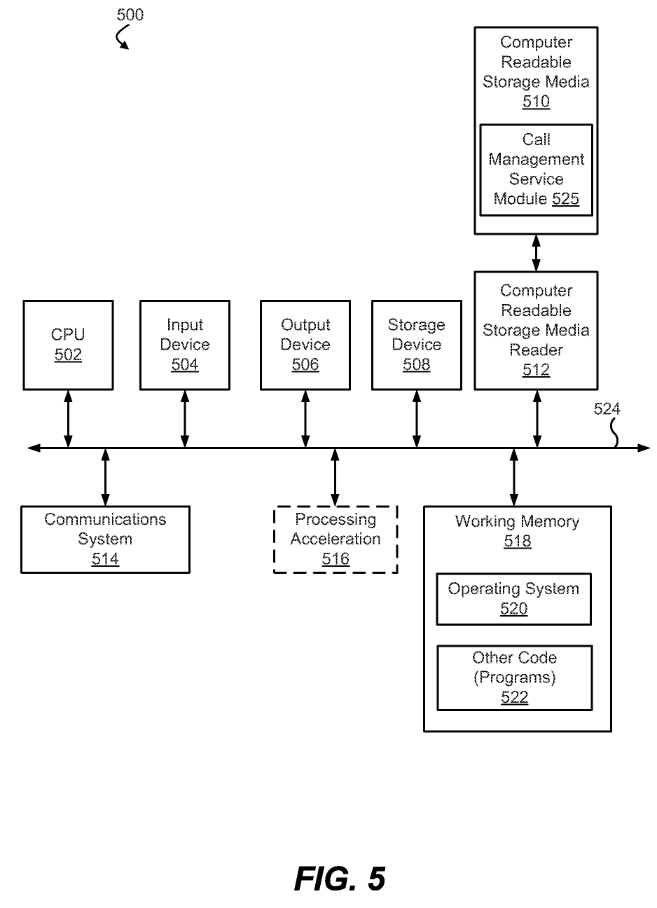

FIG. 5 illustrates a computer system in which an embodiment may be implemented. The system 500 may be used to implement any of the computer systems described above. The computer system 500 is shown comprising hardware elements that may be electrically coupled via a bus 524. The hardware elements may include at least one central processing unit (CPU) 502, at least one input device 504, and at least one output device 506. The computer system 500 may also include at least one storage device 508. By way of example, the storage device 508 can include devices such as disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system 500 may also include a processing acceleration unit 516, which can include a digital signal processor (DSP), a special-purpose processor, and/or the like.

The computer-readable storage media reader 512 can further be connected to a computer-readable storage medium 510, together (and in combination with storage device 508 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 510 may be non-transitory such as hardware storage devices (e.g., RAM, ROM, EPROM (erasable programmable ROM), EEPROM (electrically erasable programmable ROM), hard drives, and flash memory). The communications system 514 may permit data to be exchanged with the network and/or any other computer described above with respect to the system 500. Computer-readable storage medium 510 includes a call management service module 525.

The computer system 500 may also comprise software elements, which are machine readable instructions, shown as being currently located within a working memory 518, including an operating system 520 and/or other code 522, such as an application program (which may be a client application, Web browser, mid-tier application, etc.). It should be appreciated that alternate embodiments of a computer system 500 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for call management in a telecommunications network, the method comprising:
receiving, by a media platform of the telecommunications network, a user-initiated call request originating from a mobile device of a user, wherein the user is a subscriber of a first service provider (SP) in the telecommunications network;
determining the dialed telephone number from the call request;
performing a look-up in a data storage using the dialed telephone number as an index, wherein the data storage includes a mapping of a plurality of enrolled telephone numbers to a plurality of works of promotional content, wherein at least one enrolled telephone number of the plurality of enrolled telephone numbers is registered to a provider of promotional content by a second SP in the telecommunications network; and
providing, during a call attempt, a work of promotional content of the plurality of works that correlates with the dialed telephone number.

2. The method of claim 1, further comprising validating enrollment of the dialed telephone number for a call management service.

3. The method of claim 1, wherein the call attempt is completed upon establishment of n active communication connection.

4. The method of claim 1, wherein providing the work of promotional content further comprises:
determining from the call request an identifier of the mobile device of the user;
generating a communication message that includes the correlated work of promotional content; and
transmitting the communication message to the mobile device using the identifier.

5. The method of claim 4, further comprising forwarding the call request to the mobile device of the user subsequent to transmitting the communication message.

6. The method of claim 1, wherein the dialed telephone number from the call request is registered to a first provider of promotional content, further comprising charging the first provider of promotional content for a cost of providing the work of promotional content.

7. A non-transitory computer-readable medium storing a plurality of instructions to control a data processor, the plurality of instructions comprising instructions that cause the data processor to:
receive a request to enroll a telephone number for a call management service offered by a first service provider (SP) in a telecommunications network, wherein the telephone number is registered to a provider of promotional content by the first SP;
determine promotional content of the provider of promotional content;
correlate the promotional content with the telephone number;
receive a user-initiated call request;
determine a dialed telephone number from a call request originating from a mobile device of a user matches the telephone number registered to the provider; and
provide, during a call attempt, the promotional content of the provider of promotional content.

8. The non-transitory computer-readable medium of claim 7, wherein the instructions that cause the data processor to correlate the promotional content with the telephone number comprise instructions that cause the data processor to:
store a mapping of the telephone number to the promotional content of the provider of promotional content, wherein the telephone number is registered to the provider of promotional content.

9. The non-transitory computer-readable medium of claim 7, wherein the call request originated from a mobile device of a user, wherein the user is a subscriber of a second service provider (SP) in the telecommunications network.

10. The non-transitory computer-readable medium of claim 9, wherein the instructions that cause the data processor to provide the promotional content comprise instructions that cause the data processor to:
determine from the call request an identifier of the mobile device of the user;
generate a communication message that includes the promotional content; and
transmit the communication message to the mobile device using the identifier.

11. The non-transitory computer-readable medium of claim 7, wherein the plurality of instructions further comprise instructions that cause the data processor to:
charge the provider of promotional content for a cost o provide the work of promotional content.

12. A media platform system in a telecommunications network, comprising:
a processor; and
a memory coupled to the processor, wherein the processor is configured to:
receive a user-initiated call request originating from a mobile device of a user, wherein the user is a subscriber of a first service provider (SP) in the telecommunications network;
determine the dialed telephone number from the call request;
perform a look-up in a data storage using the dialed telephone number as an index, wherein the data storage includes a mapping of a plurality of enrolled telephone numbers to a plurality of works of promotional content, wherein the at least one enrolled telephone number of the plurality of enrolled telephone numbers is registered to a provider of promotional content by a second SP in the telecommunications network; and
provide, during a call attempt between the user and the dialed telephone number, a work of promotional content of the plurality of works that correlates with the dialed telephone number.

13. The system of claim 12 wherein the processor is further configured to:
determine from the call request an identifier of the mobile device of the user;
generate a communication message that includes the correlated work of promotional content; and
transmit the communication message to the mobile device using the identifier.

14. The system of claim 12, wherein the processor is configured to forward the call request to the mobile device of the user subsequent to transmission of the communication message.

15. The system of claim 12, wherein the dialed telephone number from the call request is registered to a first provider of promotional content, and wherein the processor is configured to charge the first provider of promotional content for a cost of providing the work of promotional content.
